(19) United States
(12) Patent Application Publication
(10) Pub. No.: US 2009/0167546 A1
(43) Pub. Date: Jul. 2, 2009

(54) Grounding Monitoring Device For Work Station Operator

(76) Inventor: Hsin-Ming Yang, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 11/964,151

(22) Filed: Dec. 26, 2007

(51) Int. Cl. G08B 21/00

(52) U.S. Cl. 340/649

(57) ABSTRACT

The device detects whether an operator of a work station has properly worn a wrist strap or other ground mechanism. A major characteristic of the device is that a wireless energy transmission and detection mechanism is incorporated to sense if the operator is present in front of the work station. The device monitors the resistance of a discharge circuit composed of the operator's wrist strap. If the monitored resistance is not in a proper range, the device will automatically issue alarms, only if the wireless energy transmission and detection has sensed that the operator is indeed at the work station. Another characteristic of the device is that two or more of them could be signally connected to a centralized monitoring console through a network. As such, a user is able to remotely monitor the grounding conditions of all work stations.

### BACKGROUND OF THE INVENTION

1. Field of the Invention

The present invention generally relates to grounding monitoring devices, and more particularly to such a device that automatically monitors an operator's grounding mechanisms only when the operator is actually present in front of a work station.

2. Description of Related Art

How to prevent electro-static discharge (ESD) from damaging valuable equipment or causing critical fabrication process to fail is still an important issue in high-tech industries. It is well known that proper grounding is the essential solution. However, despite the advancement of technology, ensuring such a proper grounding is not as easy as most people imagine.

A typical manufacturing environment usually contains a number of assembly lines, and each assembly line usually contains a number of work stations, each for a specific assembly task or manufacturing operation. To prevent ESD from damaging the parts, devices, or the semi-products being assembled, the operator at the work station is usually required to wear an anti-static wrist strap, the floor is usually paved with an anti-static floor mat, and the table top of the work station is usually covered with an anti-static table mat. As illustrated in FIG. 1, the floor mat 10, table mat 20, and the wrist strap 30 are usually electrically connected to a common-point ground 40 of the work station by grounding cables, respectively (for simplicity, the drawing only shows a ground cable connecting the wrist strap 30 and the common-point ground 40). The common-point ground 40 is usually a metallic plate fixedly positioned at some place of the work station with a plastic cover for protection. The common-point grounds of an assembly line's work stations are series- or parallel-connected together, which are in turn connected to an equipment ground or an earth ground of the manufacturing facility (again, for simplicity, the equipment and earth grounds are not shown in the drawing). As such, the static electricity carried by or accumulated on an operator sitting or standing in front of the work station is discharged to the earth through the wrist strap, table mat, or the floor mat, via the common-point ground of the work station and then the equipment or earth ground of the manufacturing facility, thereby preventing potential hazards from ESD.

The aforementioned grounding structure is a proven solution and has been widely adopted for years. However, it suffers a number of disadvantages. First, this grounding structure works only if the wrist strap, the floor mat, and the table mat are properly connected to the common-point ground. However, the grounding cables therebetween could be rusted or broken, or the grounding cables could be disconnected from the common-point ground due to the movement of the operator. In addition, when the operator has to take a break or to go for lunch, he or she may take down the wrist strap and leave it on the work station. Or, in most of the existing implementations, the grounding cable of the wrist strap has a plug at one end so as to plug into a socket of the common-point ground. Therefore, the operator unplugs the grounding cable (but still wears the wrist strap) before going for a break or lunch. When the operator returns, he or she then put the wrist strap back or plug the grounding cable again. As can be imagined, a lazy operator may avoid wearing the wrist strap; or an absent-minded operator may forget to put back or re-plug the wrist strap after returning to his or her post. The static electricity carried by or accumulated on the operator cannot be discharged to the ground, and may very possible damage the valuable equipment or parts or semi-product or completed product at the work station.

### BRIEF SUMMARY OF THE INVENTION

Accordingly, the present invention provides a device to monitor whether a work station operator has properly worn a wrist strap or similar grounding mechanism, so as to obviate the aforementioned shortcomings of the prior arts.

A major characteristic of the device is that a wireless energy (e.g., infrared) transmission and detection mechanism is incorporated to sense if the operator is present in front of the work station. The device monitors the resistance of a discharge circuit composed of the operator's wrist strap. If the monitored resistance is not in a proper range, for example, when the wrist strap is not worn or the 1-MΩ resistor in the grounding cable is broken or shorted, the device will automatically issue alarms, only if the wireless energy transmission and detection mechanism has sensed that the operator is indeed present at the work station.

A second major characteristic of the device is that a detection mechanism capable of sensing the movement of warm body could be adopted to enhance the accuracy in determining that it is indeed the operator, instead of the chair or other objects, present in front of the work station.

A third characteristic of the device is that the wrist strap could be electrically connected to at least one of the floor mat and the table mat in parallel, so as to simultaneously monitor if each of these grounding mechanisms constitutes a discharge circuit having an appropriate resistance.

A fourth characteristic of the device is that the wrist strap could be electrically connected to at least one of the floor mat and the table mat in series, so as to simultaneously monitor if all these grounding mechanisms jointly constitute a discharge circuit having an appropriate resistance.

A fifth characteristic of the device is that two or more of them could be signally connected to a centralized monitoring console through a network. As such, a user is able to remotely monitor the grounding conditions of all work stations equipped with a device of the present invention from the monitoring console. Furthermore, a user of the monitoring console could even remotely turn on/off and configure the devices individually or simultaneously.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing a conventional grounding structure commonly found on a work station.

FIG. 2a is a schematic diagram showing a discharge circuit formed by a grounding monitoring device according to a first embodiment of the present invention.

FIG. 2b is a schematic diagram showing a wrist strap that works with a grounding monitoring device of the present invention.

FIG. 2c is a schematic diagram showing a discharge circuit formed by a grounding monitoring device according to a second embodiment of the present invention.

FIG. 2d is a schematic diagram showing a discharge circuit formed by a grounding monitoring device according to a third embodiment of the present invention.

FIG. 3a is a functional block diagram showing a grounding monitoring device's microprocessor circuit according to an embodiment of the present invention.

FIG. 3b is a schematic diagram showing an active-typed personnel detection unit of a grounding monitoring device of the present invention.

FIG. 3c is a schematic diagram showing a passive-typed personnel detection unit of a grounding monitoring device of the present invention.

FIG. 3d is a functional block diagram showing a grounding monitoring device's microprocessor circuit according to another embodiment of the present invention.

FIG. 4a is a functional block diagram showing a grounding monitoring device's microprocessor circuit according to yet another embodiment of the present invention.

FIG. 4b is a schematic diagram showing the grounding monitoring devices of FIG. 4a remotely monitored by a centralized console.

### DETAILED DESCRIPTION OF THE INVENTION

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

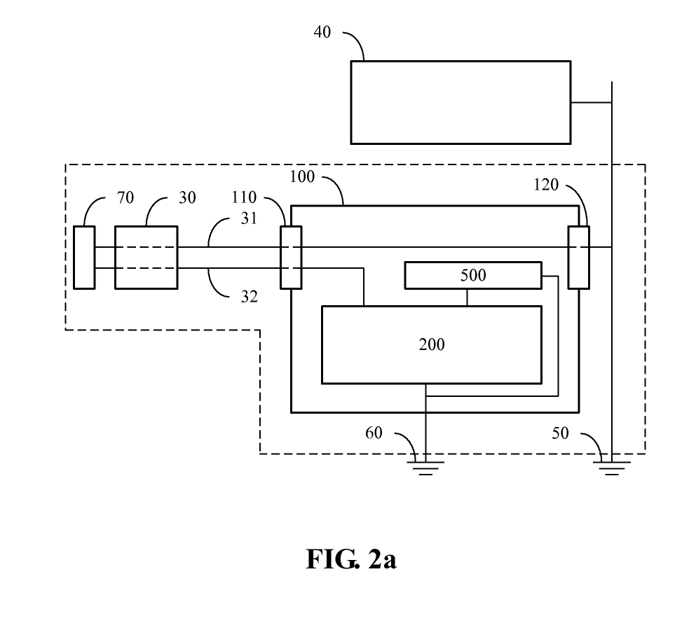

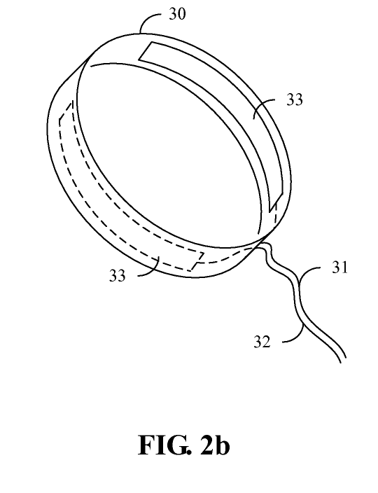

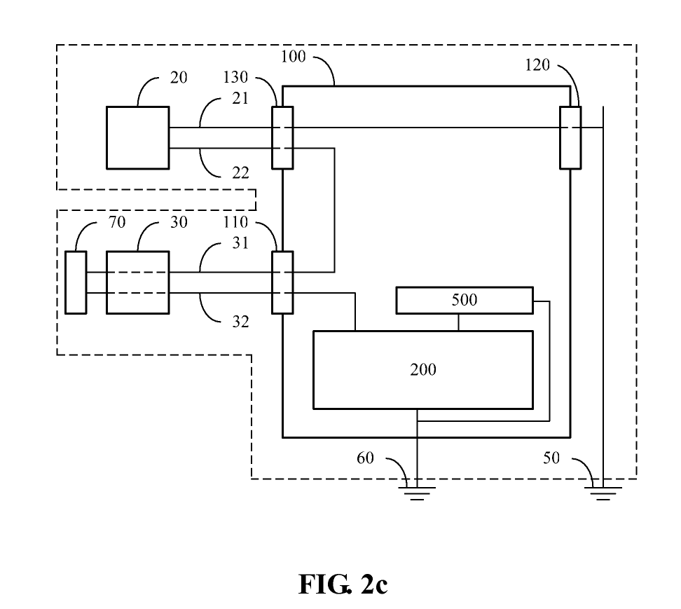

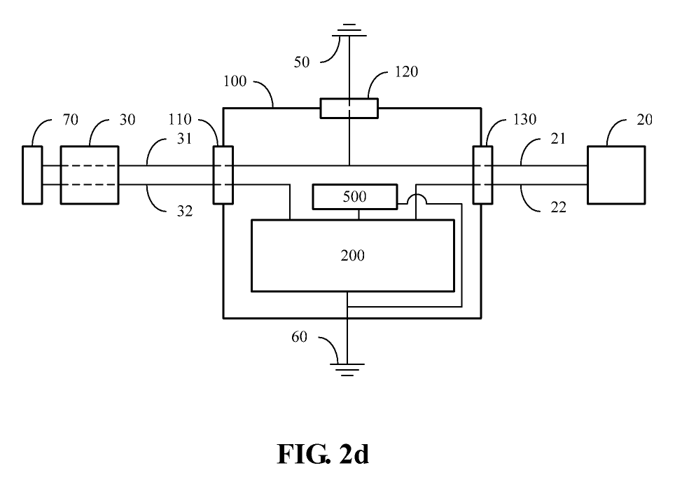

FIG. 2a is a schematic diagram showing a discharge circuit formed by a grounding monitoring device according to a first embodiment of the present invention. As illustrated, the grounding monitoring device 100 is a stand-alone device installed at an appropriate place on a work station. The device 100 mainly contains a microprocessor circuit 200 as its core. The device 100 is connected to the mains via a power cable or via an external power supply (e.g., a transformer such as those used by a notebook computer). The connection to the mains is very important in that, on one hand, the electricity extracted from the mains is processed by a power unit 500 of the device 100 to provide appropriate direct-current (DC) voltages to the microprocessor circuit 200. On the other hand, the ground 60 of the mains is thereby electrically introduced into the device 100. For simplicity, the mains, the power cable, and the external power supply are not shown in the drawing. The device 100 is also connected to the manufacturing facility's equipment ground or earth ground 50 (hereinafter, jointly referred to as earth ground) via an interface 120. This can be achieved by connecting a common-point ground 40 of the work station or, as illustrated, by directly connecting the earth ground 50. Additionally, the device 100 is connected to two conducting wires 31, 32 of a wrist strap 30 via another interface 110. As illustrated, an end of the wire 31 is electrically connected to the earth ground 50 inside the device 100 whereas an end of the wire 32 is electrically connected to the mains ground 60 via the microprocessor circuit 200. As also shown in FIG. 2b, the other ends of the wires 31, 32 are connected to two conducting plates 33 embedded in an insulating casing of the wrist strap 30, respectively. The conducting plates 33 are usually exposed from the inside of the insulating casing so as to contact an operator's wrist skin 70. As such, when the operator has properly worn the wrist strap 30, a discharge circuit, shown by the dashed lines of FIG. 2a, is established from the mains ground 60, through the earth, the earth ground 50, the wire 31, the skin 70, the wire 32, and then via the microprocessor circuit 200. A major function of the microprocessor circuit 200 is in determining if the discharge circuit has an appropriate resistance (or, more accurately put, the resistance seen from the microprocessor circuit 200 between the second wire 32 and the mains ground 60).

Please note that the interface 110 between the grounding cable of the wrist strap 30 and the device 100 could be dynamically plugged and unplugged. For example, the wrist strap 30 has a plug at an end and the device 100 has a compatible socket. In alternative embodiments, the interface 110 could provide fixed connection only. Similarly, the interface 120 to the earth ground 50 could provide either fixed or dynamic connection.

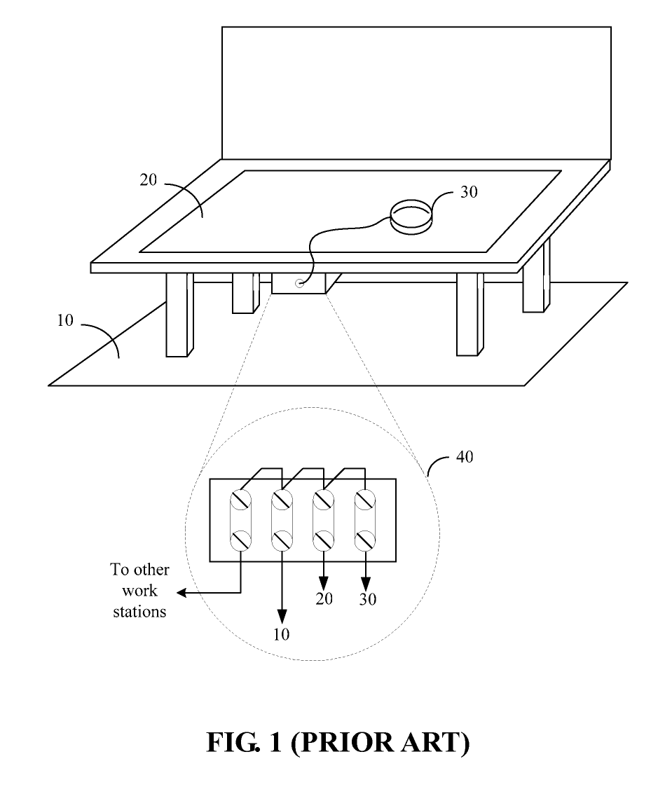

The present embodiment only monitors the wrist strap 30. The floor mat 10 and table mat 20 of FIG. 1 are still connected to the common-point ground 40. FIG. 2c is a schematic diagram showing a discharge circuit formed by a grounding monitoring device according to a second embodiment of the present invention. As illustrated, the device 100 of the present embodiment also functions as the common-point ground to the work station. The two wires 21, 22 of the grounding cable of the table mat 20 are electrically connected to the earth ground 50 and the wrist strap 30, respectively, via an interface 130. For simplicity, the floor mat 10 is omitted in the drawing; however, a person of ordinary skill could easily extend the idea to cover floor mat 10 (whose ground cable also contains two wires) as well. Again, the interface 130 could provide fixed or dynamic connection. As illustrated, a larger discharge circuit, expressed by the dashed lines, is formed with the wrist strap 30 and the table mat 20 being series-connected, and the microprocessor circuit 200 is therefore able to monitor the table mat 20 and the wrist strap 30 simultaneously. In other words, in addition to the wrist strap 30, the device 100 is able to incorporate the monitoring of at least one of the table mat 20 and the floor mat 10 together.

The microprocessor circuit 200 determines if the discharge circuit is normal by measuring the resistance of the discharge circuit. However, if there is indeed something wrong with the discharge circuit, the present embodiment is not able to tell whether it is the wrist strap 30, the floor mat 10, or the table mat 20 causing the problem. FIG. 2d is a schematic diagram showing a discharge circuit formed by a grounding monitoring device according to a third embodiment of the present invention. As illustrated, the wrist strap 30 and the table mat 20 are parallel-connected between the earth ground 50 and the microprocessor circuit 200. As such, the microprocessor circuit 200 is able to monitor a discharge circuit containing the wrist strap 30 and another discharge circuit containing the table mat 20 individually and simultaneously. Again, a person with ordinary skill can easily extend the same idea to incorporate the monitoring of the floor mat 10 and therefore the detail is omitted here. Please note that the microprocessor circuit 200 of FIG. 2c is not identical to the microprocessor circuit 200 of FIG. 2d, as additional parts are required in the parallel configuration of FIG. 2d to measure an additional discharge circuit. Again, a person of ordinary skill could easily extend the microprocessor circuit of series configuration to cover the microprocessor circuit of parallel configuration. Following the same line of through, the present invention could be further extended to cover: (1) the monitoring of other grounding mechanisms similar to the wrist strap, the table mat, or the floor mat, as long as they also use two-wire grounding cables; (2) configurations where some grounding mechanisms are parallel-connected and some are series-connected; and (3) configurations with more than one wrist strap, table mat, or floor mat. For simplicity, the present specification will focus on the microprocessor circuit 200 of series configurations (e.g., FIG. 2c) and use only the wrist strap 30 as example to explain the details of the device 100.

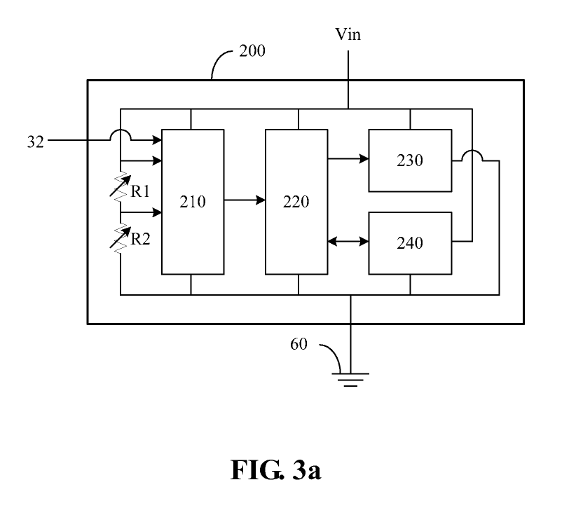

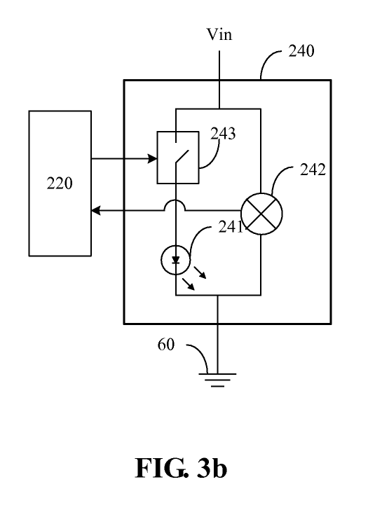

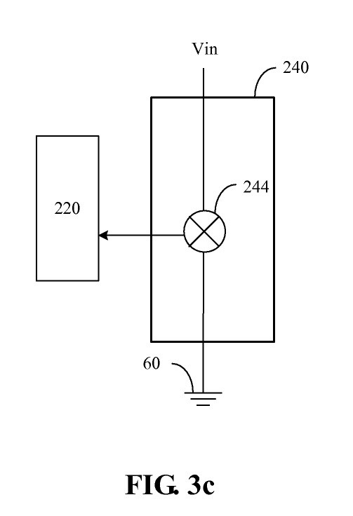

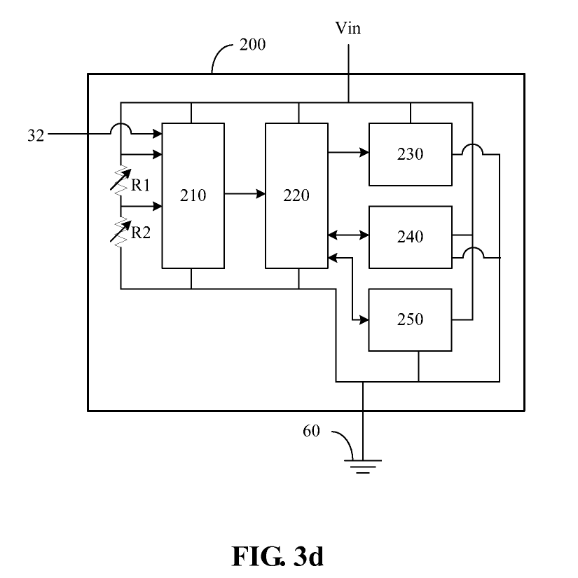

FIG. 3a is a functional block diagram showing a grounding monitoring device's microprocessor circuit according to an embodiment of the present invention. In the drawing, Vin is a DC voltage produced by the power unit 500 after drawing electricity from the mains to drive the microprocessor circuit 200.

As illustrated, the microprocessor circuit 200 contains a comparison and amplification unit 210 which is mainly composed of at least an operation amplifier. The variable resistors R1 and R2 are actually an integral part of the comparison and amplification unit 210 but they are separately shown for easier explanation. The provision of the series-connected R1 and R2 allows the operation amplifier(s) in the comparison and amplification unit 210 to see if the resistance of the discharge circuit introduced by the wire 32 has a value between R2 and R1. In other words, the function of the comparison and amplification unit 210 is to test if the resistance of the discharge circuit is bounded by a smaller first resistance (e.g., R2) and a larger resistance (e.g., R1). If the operator does not put on the wrist strap 30, or the ground cable of the wrist strap 30 is rusted or broken, the resistance of the discharge circuit would be greater than the second (i.e., larger) resistance. On the other hand, if the operator has properly worn the wrist strap 30 and the grounding cable and everything else is normal, the resistance shouldn't be less than the first (i.e., smaller) resistance either. Therefore, if the resistance of the discharge circuit is greater than the second resistance or less than the first resistance, the comparison and amplification unit 210 would trigger a microprocessor unit 220. In alternative embodiments, it is possible to have only a single variable resistor R1 (i.e., omitting the variable resistor R2). These embodiments therefore will only detect if the resistance of the discharge circuit is greater than a specific value (i.e., the resistance of the variable resistor R1). There are also embodiments where the first and second resistances are implemented by fixed resistors. The advantage of having variable resistors is that, depending on whether the discharge circuit covers only the wrist strap, or has additional grounding mechanism such as table mat series-connected, the first and second resistances can be dynamically adjusted to reflect these variations. The adjustment of the variable resistors R1 and R2 can be conducted by manually twisting knobs or by a control panel, both on the device 100's casing. More details will be given later.

The microprocessor unit 220 is the core of the device 100. It could be a microcontroller unit (MCU), a single chip containing a processor, RAM, ROM, clock, and I/O control units. Millions of MCUs are in used in various devices ranging from automobiles to laser printers. The present specification therefore will not go into details.

After being triggered by the comparison and amplification unit 210, the microprocessor unit 220 activates an alarm unit 230 to issue alarms so as to remind the operator to wear the wrist strap or to get the attention of supervisors or managers. The alarm unit 230 contains one or more lamps, for example, made of light emitting diodes (LEDs). The alarm unit 230 turns on or flashes these lamps to provide visual alarms. The alarm unit could also contain one or more speakers or buzzers to provide audio alarms. These audio or visual alarms could be implemented individually or together. The alarm unit 230 could further contain electronic or mechanical relays to trigger additional devices. When the abnormality detected by the comparison and amplification unit 210 is resolved, the microprocessor unit 220 is notified to turn off the alarm unit 230. In alternative embodiments, there are reset buttons on the casing or control panel of the device 100 to shutdown the audio or visual alarms.

A personnel detection unit 240 is provided to see if there is indeed an operator present in front of in front of the device 100 (i.e., in front of the work station). The personnel detection unit 240 may provide a presence signal when an operator appears or is present and an absence signal when the operator leaves or is absent. The presence and absence signals are delivered to the microprocessor unit 220 as well. As such, the microprocessor unit 220 is able to engage the detection of the discharge circuit's resistance and to trigger the alarm unit 230 if required, only when a operator is present in front of the device 100 (e.g., the microprocessor unit 220 has received. a presence signal but not an absence signal yet). When the operator has to leave the work station and take off the wrist strap 30 or disconnect the wrist strap 30 from the interface 110, as shown in FIGS. 2a, 2b, and 2c, the microprocessor unit 220 will be triggered by the comparison and amplification unit 210 as the latter has seen an abnormal resistance from the discharge circuit (the discharge circuit is open-circuited). The microprocessor unit 220, as it has already picked up an absence signal from the personnel detection unit 240, will not initiate the alarm unit 230 to issue alarms. However, once the personnel detection unit 240 has sensed the presence of the operator, the microprocessor unit 220 automatically begins to activate the alarm unit 230 in accordance with the result of the comparison and amplification unit 210 so that the operator will be reminded to wear or re-plug the wrist strap 30. In other words, the absence signal from the personnel detection unit 240 functions like an inhibitor to prevent the microprocessor unit 220 from activating the alarm unit 230 whereas the presence signal functions like an enabler to the microprocessor unit 220. Please note that the personnel detection unit 240 only provides the detection result regarding whether the operator is present or absent. The decision about whether to activate the alarm unit 230 is still carried out by the microprocessor unit 220. To prevent erroneous judgment and to allow the operator some time to settle, the microprocessor unit 220 will remain inhibited after receiving the presence signal for a period of time (e.g., 5 seconds) and, if there is no absence signal within this period of time, the microprocessor unit 220 will then activate the alarm unit 230 in accordance with the result of the comparison and amplification unit 210. In contrast, if an absence signal is received at any point of time, the microprocessor unit will stop activating the alarm unit 230 immediately.

The personnel detection unit 240 can employ either an active means or a passive means in detecting the presence of an operator. FIG. 3b is a schematic diagram showing an active-typed personnel detection unit of a grounding monitoring device of the present invention. As illustrated, the active-typed personnel detection unit 240 has a wireless energy transmitter, such as the infrared LED 241 in the drawing or radar, which can radiate an electromagnetic or supersonic wave covering a limited range to a front side of the device 100 (i.e., towards the operator). The active-typed personnel detection unit 240 also requires a sensor to detect the energy reflected from the operator, such as the infrared receiver 242 in the drawing. This active-typed detection technique has been widely applied in various fields and there are many different transmitters, sensors, and related circuits disclosed and commercially available. To give a few examples, active-typed detection based on infrared is commonly found on auto-flush toilets, those based on supersonic waves are commonly found on automobile radar backup alarm systems. As illustrated, an output terminal of the microprocessor unit 220 controls an electronic switch 243 to turn on or off the infrared LED 241. On the other hand, the output of the infrared receiver 242 is delivered to an input terminal of the microprocessor unit 242.

The active-typed detection is a rather effective solution to the present invention. However, there are usually chairs also positioned in front of the work stations. The personnel detection unit 240 couldn't distinguish whether it is the operator or the chair (after the operator has left) that is present in front of the work station. The passive-typed detection would provide a more accurate result in this respect. Currently the most common passive-typed detection is based of passive infrared (PIR) sensors, which are able to pick up the movement of a warm object within a specific range. PIR sensors are quite common in security-related applications. However, their adoption has declined in recent years as they cannot distinguish the movement made by a dog or a cat from the movement made by a human being, which are all warm bodies. Interestingly, PIR sensors are quite adequate for the present invention as they have no problem in differentiating the warm human body and the cold chair. As shown in FIG. 3c, the passive-typed personnel detection unit 240 requires a single PIR sensor 244, which is even simpler structurally.

There is another passive-typed detection technique which uses a camera to capture images and performs image analysis to detect object movement. In security surveillance arena, such motion detection technique has already been proven to have a significant accuracy. However, to equip a camera in the personnel detection unit 240 and to make the microprocessor unit 220 powerful enough to carry out image processing would make the device 100 much more complicated and costly.

FIG. 3d is a functional block diagram showing a grounding monitoring device's microprocessor circuit according to another embodiment of the present invention. In the present embodiment, the microprocessor circuit 200 contains an additional control interface unit 250, which provide a human-machine interface to the device 100. The control interface unit 250 signally connects one or more buttons (not shown) forming a control panel on the casing of the device 100. The control interface unit 250 in turn connects a number of input terminals of the microprocessor unit 220 for configuring some operation parameters of the microprocessor unit 220, such as the lead time after receiving a presence signal, turning on and off the detection function of the device 100, turning on and off the alarms, etc. The control interface unit 250 can further connect a small-scale liquid crystal display (LCD) panel for showing the current status of the device 100, for examining the parameter values, etc. The control interface unit 250 could also display alarm messages on the LCD panel.

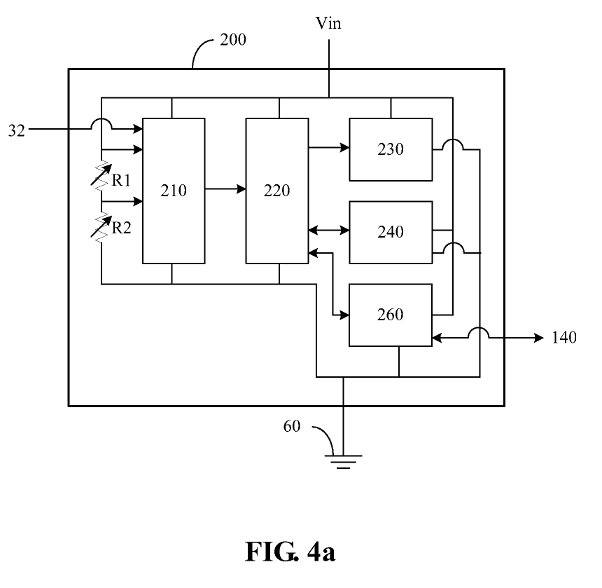

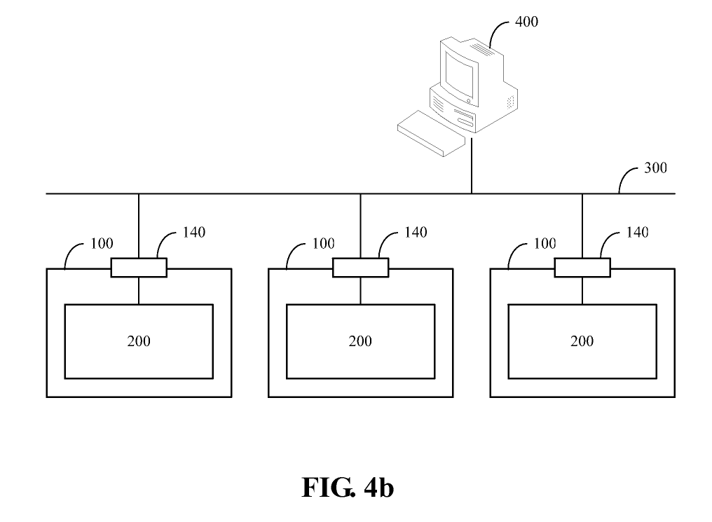

As a typical manufacturing environment contains multiple assembly lines and each assembly line contains multiple work stations, it could be rather time consuming and laborious to configure and monitor the device 100 at each work station. Therefore, FIG. 4a shows another embodiment of the microprocessor circuit 200, which contains an addition network interface unit 260. The network interface unit 260 connects a network interface 140 of the device 100 and the input and output terminals of the microprocessor unit 220 for two-way data exchange. The network interface 140 provides the physical connection to an external network 300, which could be a wired or wireless local area network conforming to the 802.11x specifications, or a control network conforming to the RS-485, Lonworks, etc. specifications, to name just a few. Depending on the requirement of the network 300, the network interface 140 should have a compatible physical connection means (such as an RJ-45 socket for hooking onto a local area network). Then, as shown in FIG. 4b, the devices 100 at different work stations can be remotely monitored by a centralized console 400 through the network 300. Therefore, when the microprocessor unit 220 is triggered due to an abnormal resistance found on the discharge circuit, the microprocessor unit 220 not only activates the alarm unit 230 to issue visual or audio alarms, but also sends a message via the network interface unit 260 and the network 300 to the console 400. In alternative embodiments, the console 400 could periodically poll and communicate with the microprocessor unit 220 of each device 100 to obtain the status (e.g., whether an abnormal condition in the discharge circuit is detected) thereof. The console 400 could also configure the parameters, turn on and off the detection function, etc. of all devices 100 simultaneously, or of a specific device 100 individually.

Despite that wrist straps are the most common ground mechanism, and that the proper wearing of the wrist strap has been described so far as the main detection target of the grounding monitoring device, it has to be pointed out that the spirit of the present invention is not limited to the wrist strap only. The present invention could actually be applied to any grounding mechanism that employs two conducting wires to contact two separate spots of the human body to discharge the static electricity.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A device for monitoring a grounding mechanism worn by an operator at a work station, said grounding mechanism having at a first conducting wire and a second conducting wire, a first end of said first and second conducting wires contacting two spots of said operator's body, respectively, when said grounding mechanism is properly worn, said device comprising:
a power unit electrically connected to a mains, said power unit extracting a mains ground from said mains and producing at least an appropriate direct-current voltage to drive said device;
a first interface electrically connected to a second end of said first and second conducting wires;
a second interface electrically connected to an earth ground and said second end of said first conducting wire;
a comparison and amplification unit electrically connected to said second end of said second conducting wire via said first interface, said comparison and amplification unit having at least a first resistor, said comparison and amplification unit comparing a grounding resistance seen between said second conducting wire and said mains ground and the resistance of said first resistor, said comparison and amplification unit producing an abnormal signal when said grounding resistance is greater than the resistance of said first resistor;
a personnel detection unit having a wireless energy detection mechanism capable of sensing the presence of said operator in front of said device at least within a limited range and producing at least one of a presence signal and a absence signal accordingly;
a microprocessor unit receiving said presence and absence signals from said personnel detection unit and said abnormal signal from said comparison and amplification unit, said microprocessor unit producing an activation signal if said abnormal signal and said presence signal are received and said absence signal is not subsequently received within a period of time; and
an alarm unit activated by said activation signal from said microprocessor unit to produce at least one of a visual alarm and an audio alarm.

2. The device according to claim 1, wherein said grounding mechanism is a wrist strap; said wrist strap has two conducting plates contacting two spots of said operator's skin; said first ends of said first and second conducting wires of said wrist strap connects said two conducting plates, respectively.

3. The device according to claim 1, further comprising a third interface electrically connected to a third conducting wire and a fourth conducting wire of one of a table mat and a floor mat.

4. The device according to claim 3, wherein said third conducting wire is connected to said earth ground of said second interface; and said fourth conducting wire is connected to said second end of said first conducting wire.

5. The device according to claim 1, wherein said comparison and amplification unit further has a second resistor; said second resistor has a smaller resistance than said first resistor; and said comparison and amplification unit produces said abnormal signal when said grounding resistance is less than the resistance of said second resistor.

6. The device according to claim 1, wherein said wireless energy detection mechanism comprises an energy transmitter and an energy sensor; said energy transmitter radiates energy towards a front side of said device covering said limited range; and said energy sensor detects energy being reflected.

7. The device according to claim 1, wherein said wireless energy detection mechanism comprises a passive infrared sensor.

8. The device according to claim 1, further comprising a control interface unit as a man-machine interface to said device by providing input and output to said microprocessor unit.

9. The device according to claim 1, further comprising a network interface unit providing two-way data exchange between said microprocessor unit and a network.

10. The device according to claim 9, wherein said microprocessor unit delivers said activation signal to a remote console via said network interface unit and said network.
